(19) United States
(12) Patent Application Publication
(10) Pub. No.: US 2026/0312690 A1
(43) Pub. Date: Oct. 8, 2026

(54) OPTICAL TRANSMISSION SYSTEM AND OPERATING METHOD THEREOF

(71) Applicant: AGENCY FOR DEFENSE DEVELOPMENT, Daejeon (KR)

(72) Inventors: Seung Ho KIM, Daejeon (KR); Hyeok Gyu CHOI, Daejeon (KR); Joo Hee HAN, Daejeon (KR)

(21) Appl. No.: 19/634,798

(22) Filed: Mar. 31, 2026

(30) Foreign Application Priority Data
Apr. 2, 2025 (KR) 10-2025-0043072

(51) Int. Cl. H04B 10/50; H04B 10/112; H04B 10/118; H04B 10/54

(52) U.S. Cl. CPC H04B 10/505; H04B 10/112; H04B 10/118; H04B 10/54

(57) ABSTRACT

An optical transmission system according to an example embodiment of the present disclosure includes a transmitter configured to generate an electrical signal, a laser diode configured to generate a source optical signal, a modulator configured to modulate the electrical signal into a target optical signal based on the source optical signal, and a variable optical attenuator (VOA) configured to apply an amplitude modulation (AM) tone to the target optical signal.

### FIELD OF THE INVENTION

This application claims the benefit of Korean Patent Application No. 10-2025-0043072, filed on Apr. 2, 2025, in the Korean Intellectual Property Office, the disclosure of which is incorporated herein by reference in its entirety.

### FIELD OF THE INVENTION

Example embodiments relate to an optical transmission system and an operating method thereof, and more particularly, to an optical transmission system capable of efficiently implementing AM tones for precise tracking and data transmission of laser communication terminals, and an operating method thereof.

### DESCRIPTION OF THE RELATED ART

A demand for space-to-ground laser communication links has surged significantly due to the recent rapid increase in communication requirements between space and Earth. Laser communication technology plays a crucial role in enabling high-speed data communication between space and Earth, particularly in military and civilian sectors such as the Space Development Agency (SDA), Starlink, and OneWeb. The strategic importance of this technology is increasingly highlighted in defense industries, including satellite reconnaissance, military data links, missile tracking, and command and control systems. Efforts are underway to adapt optical communication technologies used in terrestrial networks for the space environment, necessitating technical advancements to enhance the performance of space-based laser communication terminals.

One of critical factors in the performance of space-based laser communication terminals is the Payload Acquisition and Tracking (PAT) function, which performs precise positioning alignment and tracking between optical communication terminals. However, in space-to-ground communications, accurate tracking between laser communication terminals with very narrow beam widths is challenging due to atmospheric and solar noise. To address this issue, the SDA mandates in its space communication standards that Optical Communication Terminals (OCTs) incorporate an Amplitude Modulation tone (AM tone) and utilize it during operation.

However, typical laser communication technology lacked a specifically established method for implementing AM tones, resulting in extremely limited practical applications. This is an essential technology for the precise tracking and data transmission of laser communication terminals, necessitating a new method to efficiently implement AM tones in optical transmission systems.

The prior art document related to this disclosure is Korean Patent Publication No. 10-2021-0129091.

### SUMMARY

Accordingly, the present disclosure is directed to systems, devices, methods, and instructions for optical transmission that substantially obviate one or more problems due to limitations and disadvantages of the related art.

An aspect provides an optical transmission system with AM tone modulation capability and an operating method thereof.

Technical aspects to be achieved by the present disclosure are not limited to those mentioned above, and other technical aspects not mentioned herein will be clearly understood by those skilled in the art from the following description.

According to an aspect, there is provided an optical transmission system including a transmitter configured to generate an electrical signal, a laser diode configured to generate a source optical signal, a modulator configured to modulate the electrical signal into a target optical signal based on the source optical signal, and a variable optical attenuator (VOA) configured to apply an amplitude modulation (AM) tone to the target optical signal.

According to an example embodiment, the optical transmission system may further include an oscillator configured to generate an electrical signal with the AM tone, and a level controller configured to adjust the AM tone.

According to an example embodiment, the level controller may further be configured to identify a target modulation index (MI) and determine the AM tone corresponding to the target modulation index.

According to an example embodiment, the optical transmission system may further include a radio frequency (RF) amplifier configured to amplify a level of the electrical signal to deliver to the modulator.

According to an example embodiment, the modulator may include a Mach-Zehnder modulator, and the optical transmission system may further include a bias controller configured to adjust a bias voltage of the Mach-Zehnder modulator.

According to another aspect, there is also provided an optical transmission system including a digital-to-analog converter (DAC) configured to output an electrical signal with an AM tone applied, a laser diode configured to generate a source optical signal, and a modulator configured to modulate the electrical signal into a target optical signal with the AM tone applied based on the source optical signal.

According to an example embodiment, the DAC may further be configured to identify a target MI and determine an amplitude of the AM tone corresponding to the target modulation index.

According to an example embodiment, the optical transmission system may further include a level control circuit configured to perform level optimization for amplifying the electrical signal output from the DAC, and an RF amplifier configured to amplify a level of the electrical signal to deliver to the modulator.

According to an example embodiment, the modulator may include a Mach-Zehnder modulator, and the optical transmission system may further include a bias controller configured to adjust a bias voltage of the Mach-Zehnder modulator.

According to yet another aspect, there is also provided an operating method of an optical transmission system including generating an electrical signal by a transmitter, generating a source optical signal by a laser diode, modulating the electrical signal into a target optical signal based on the source optical signal by a modulator, and applying an AM tone to the target optical signal by a variable optical attenuator.

According to still another aspect, there is also provided an operating method of an optical transmission system including outputting an electrical signal with an AM tone applied by a DAC, generating a source optical signal by a laser diode, and modulating the electrical signal into a target optical signal with the AM tone applied based on the source optical signal by a modulator.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram illustrating each configuration of an optical transmission system that implements an amplitude modulation (AM) tone modulation function using a variable optical attenuator according to some example embodiments of the present disclosure;

FIG. 2 is a schematic diagram illustrating each configuration of an optical transmission system that implements an AM tone modulation function using a variable optical attenuator according to some example embodiments of the present disclosure;

FIG. 3 exemplarily illustrates an optical signal with an AM tone applied according to some example embodiments of the present disclosure;

FIG. 4 is a schematic diagram illustrating each configuration of an optical transmission system that implements an AM tone modulation function using a digital-to-analog converter (DAC) according to some example embodiments of the present disclosure;

FIG. 5 is a schematic diagram illustrating each configuration of an optical transmission system that implements an AM tone modulation function using a DAC according to some example embodiments of the present disclosure;

FIG. 6 exemplarily illustrates a DAC output electrical signal with an AM tone applied according to some example embodiments of the present disclosure;

FIG. 7 is a flowchart illustrating an operating method of an optical transmission system including a variable optical attenuator according to some example embodiments of the present disclosure; and

FIG. 8 is a flowchart illustrating an operating method of an optical transmission system including a DAC according to some example embodiments of the present disclosure.

### DETAILED DESCRIPTION

Hereinafter, example embodiments of the present disclosure will be described in detail with reference to accompanying drawings.

In describing example embodiments, technical details that are well known in the art to which the present disclosure pertains and are not directly related to the present disclosure are omitted. This is to avoid obscuring the essence of the present disclosure and to convey it more clearly by omitting unnecessary explanations.

For the same reason, some components in the accompanying drawings are exaggerated, omitted, or shown schematically. Furthermore, the size of each component does not necessarily reflect its actual size. Identical or corresponding components in each drawing are assigned the same reference numerals.

The advantages and features of the present disclosure, and the methods for achieving them, will become clear upon reference to the detailed description of example embodiments provided below, together with the accompanying drawings. However, the present disclosure is not limited to example embodiments disclosed herein, but may be implemented in various different forms. These example embodiments are provided merely to make the disclosure complete and to fully inform those skilled in the art to which the present disclosure pertains of the scope of the disclosure. The scope of the present disclosure is defined solely by the scope of the claims. Throughout the specification, the same reference numerals refer to the same components.

At this point, it can be understood that each block in the processing flowchart drawings and the combinations of the flowchart drawings can be executed by computer program instructions. These computer program instructions can be loaded onto the processor of a general-purpose computer, a special-purpose computer, or other programmable data processing device. Thus, the instructions executed by the processor of a computer or other programmable data processing device provide a means for performing the functions described in the flowchart block(s). These computer program instructions may also be stored in computer-accessible or computer-readable memory that can direct a computer or other programmable data processing device to implement a function in a particular manner, so that the instructions stored in the computer-accessible or computer-readable memory can also produce a manufactured article that includes instruction means for performing the function described in the flowchart block(s). Since computer program instructions can also be loaded onto a computer or other programmable data processing device, a series of operational steps can be performed on the computer or other programmable data processing device to create a computer-executable process, so that the instructions executed on a computer or other programmable data processing device can also provide steps for executing the functions described in the flowchart block(s).

Furthermore, each block may represent a module, segment, or portion of code including one or more executable instructions for performing specified logical function(s). It should also be noted that in some alternative execution examples, the functions mentioned in the blocks may occur out of sequence. For example, two blocks shown consecutively may in fact be performed substantially simultaneously, or those blocks may sometimes be performed in reverse order depending on the corresponding function.

At this point, the term ‘~part’ used in this example embodiment refers to a software or hardware component such as an FPGA or ASIC, and the ‘~part’ performs certain roles. However, ‘~part’ is not limited to software or hardware. The ‘~part’ may be configured to reside on an addressable storage medium or to drive one or more processors. Therefore, for example, ‘~part’ may include components such as software components, object-oriented software components, class components, and task components, as well as processes, functions, attributes, procedures, subroutines, segments of program code, drivers, firmware, microcode, circuits, data, databases, data structures, tables, arrays, and variables. The functionality provided within components and ‘~parts’ may be combined into a smaller number of components and ‘~parts’ or further separated into additional components and ‘~parts’. Furthermore, components and ‘~parts’ may also be implemented to drive one or more CPUs within a device or a secure multimedia card.

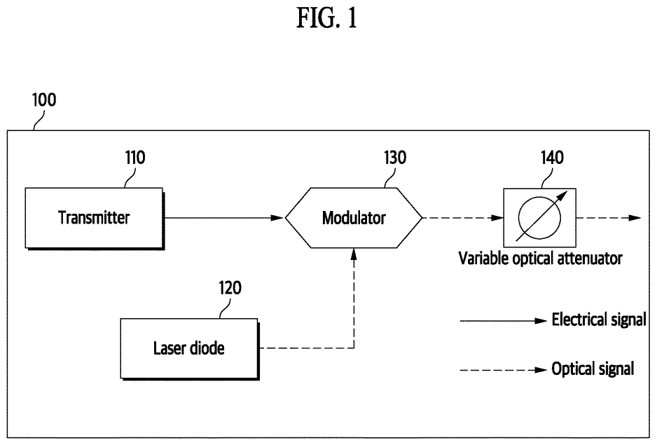

FIG. 1 is a schematic diagram illustrating each configuration of an optical transmission system that implements an amplitude modulation (AM) tone modulation function using a variable optical attenuator according to some example embodiments of the present disclosure. A system 100 shown in FIG. 1 depicts only the components relevant to the present example embodiment. Therefore, it is obvious to those skilled in the art that the system 100 may further include other general-purpose components in addition to those shown in FIG. 1.

Referring to FIG. 1, components of the optical transmission system 100 according to some example embodiments of the present disclosure are illustrated. In an example embodiment, the optical transmission system 100 includes a transmitter 110 configured to generate an electrical signal, a laser diode 120 configured to generate a source optical signal, a modulator 130 configured to modulate the electrical signal into a target optical signal based on the source optical signal, and a variable optical attenuator 140 configured to apply an AM tone to the target optical signal. In an example embodiment, the optical transmission system 100 may be included within a laser communication terminal performing laser communication between space and the ground.

In an example embodiment, the transmitter 110 may include a high-speed transceiver and may generate a high-speed electrical data signal containing digital data for communication. This electrical signal may then be used as a base signal to be converted into an optical signal via the modulator 130.

In an example embodiment, the laser diode 120 may include a tunable laser diode capable of generating an optical signal of a desired wavelength. The source optical signal generated by the laser diode 120 is supplied to the modulator 130, where it may be modulated into a target optical signal corresponding to the electrical signal.

In an example embodiment, the modulator 130 may modulate the source optical signal into the target optical signal according to the electrical signal, based on the electrical signal output from the transmitter 110 and the source optical signal output from the laser diode 120.

In an example embodiment, the modulator 130 may include a Mach-Zehnder modulator. A Mach-Zehnder modulator is an optical modulation device that operates based on optical interference and electrical phase control. In an example embodiment, a continuous source optical signal input from the laser diode 120 is split into two paths and travels within the Mach-Zehnder modulator, where the phase of the light may be adjusted according to the magnitude of the electrical signal applied to each path. These two optical paths of which phases are adjusted are then recombined, producing an interference effect. Consequently, the intensity of the output optical signal may vary in response to the electrical signal. As a result, a target optical signal reflecting digital data may be generated based on the electrical signal input to the modulator.

In an example embodiment, the variable optical attenuator 140 may include a high-speed variable optical attenuator and may apply an AM tone to the target optical signal generated by the modulator 130. Applying an AM tone herein may mean using a low-frequency (e.g., 40 kHz) electrical signal in the form of a sine wave as a control input to the variable optical attenuator 140, thereby adjusting the amplitude the optical signal to vary periodically over time. For this purpose, an AM tone electrical signal may be applied to the drive section of the variable optical attenuator 140, and the amplitude of the target optical signal may be periodically modulated in the form of the AM tone. When the optical signal with the AM tone applied is detected at the receiving terminal, the receiving terminal may analyze the frequency components embedded within the signal to estimate the location of the transmitting terminal or the optical path. This may contribute to enhancing the precision tracking capabilities and improving the reliability of communications between space and ground.

In an example embodiment, the variable optical attenuator 140 may further be combined with an oscillator that generates an AM tone electrical signal of an arbitrary frequency, and a level controller that adjusts the modulation index (MI) by controlling the AM tone.

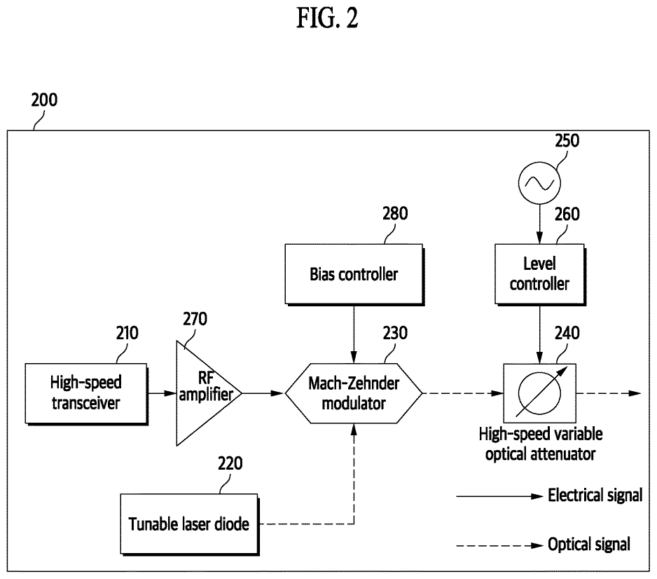

FIG. 2 is a schematic diagram illustrating each configuration of an optical transmission system that implements an AM tone modulation function using a variable optical attenuator according to some example embodiments of the present disclosure. The system 200 shown in FIG. 2 depicts only the components relevant to the present example embodiment. Therefore, it is obvious to those skilled in the art that the system 200 may further include other general-purpose components in addition to those shown in FIG. 2.

Referring to FIG. 2, components of an optical transmission system 200 according to some example embodiments are illustrated. In an example embodiment, the optical transmission system 200 includes a high-speed transceiver 210 configured to generate an electrical signal, a tunable laser diode 220 configured to generate a source optical signal, a Mach-Zehnder modulator 230 configured to modulate the electrical signal into a target optical signal based on the source optical signal, a high-speed variable optical attenuator 240 configured to apply an AM tone to the target optical signal, an oscillator 250 configured to generate an electrical signal with an AM tone, a level controller 260 configured to adjust an AM tone, an RF amplifier 270 configured to amplify the level of the electrical signal output from the high-speed transceiver 210, and a bias controller 280 configured to adjust the bias of the Mach-Zehnder modulator 230. In an example embodiment, the optical transmission system 200 may be included within a laser communication terminal performing laser communication between space and the ground.

In an example embodiment, the high-speed transceiver 210 may generate a high-speed data electrical signal containing digital data for communication. This electrical signal may subsequently be amplified by the RF amplifier 270 and used as a base signal to be converted into an optical signal by the Mach-Zehnder modulator 230.

In an example embodiment, the RF amplifier 270 may amplify the level of the electrical signal output from the high-speed transceiver 210 and deliver it to the Mach-Zehnder modulator 230. The RF amplifier 270 may amplify the level of the electrical signal to a range acceptable to the modulator.

In an example embodiment, the tunable laser diode 220 may generate an optical signal of a desired wavelength. The source optical signal generated by the tunable laser diode 220 is supplied to the Mach-Zehnder modulator 230, where it may be modulated into a target optical signal corresponding to an electrical signal.

In an example embodiment, the Mach-Zehnder modulator 230 may modulate the source optical signal into the target optical signal according to the electrical signal, based on the electrical signal output from the high-speed transceiver 210 and the source optical signal output from the tunable laser diode 220.

In an example embodiment, the bias controller 280 may adjust the bias voltage of the Mach-Zehnder modulator 230. In an example embodiment, the bias controller 280 may control the bias voltage of the Mach-Zehnder modulator 230 to ensure the Mach-Zehnder modulator 230 operates stably within its linear operating region. In an example embodiment, the bias controller 280 detects drift phenomena where the bias gradually changes due to disturbances such as temperature changes, power supply noise, or load variations that may occur during operation of the Mach-Zehnder modulator 230, and automatically compensates for this. This helps the Mach-Zehnder modulator 230 maintain stable modulation performance over extended periods.

In an example embodiment, the high-speed variable optical attenuator 240 may apply an AM tone to the target optical signal generated by the Mach-Zehnder modulator 230.

In an example embodiment, the oscillator 250 may generate an AM tone electrical signal having a predetermined frequency. The AM tone electrical signal may be applied to the high-speed variable optical attenuator 240 and used to periodically vary the amplitude of the optical signal. The AM tone may function as a reference signal utilized for tracking and alignment functions at the receiving terminal.

In an example embodiment, the level controller 260 may adjust the AM tone electrical signal output from the oscillator 250 to determine the modulation index (MI) of the signal applied to the high-speed variable optical attenuator 240.

In an example embodiment, the level controller 260 may be configured to identify a target modulation index and determine an AM tone corresponding to the target modulation index. The level controller 260 may determine the AM tone input from the oscillator 250 based on the target modulation index required by the system. In an example embodiment, the level controller 260 may be configured to determine at least one of the amplitude, offset, and phase of the AM tone to correspond to the target modulation index. In an example embodiment, the modulation index is an indicator that quantitatively represents how deeply the AM tone modulates the amplitude of the optical signal and may be defined based on the difference between the maximum output and minimum output of the optical signal.

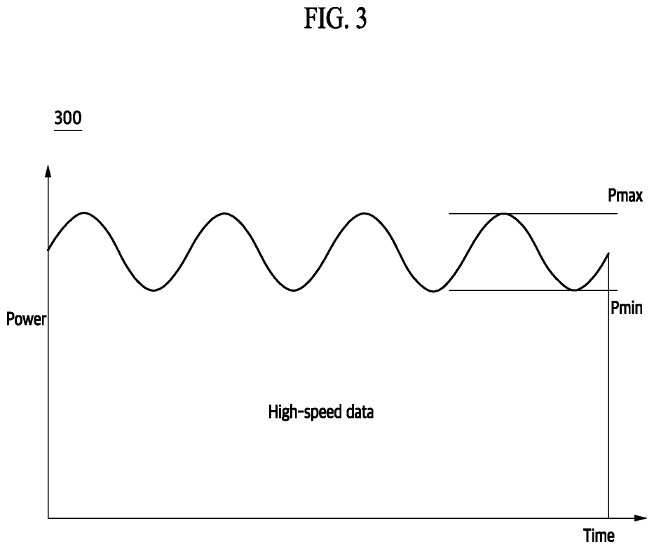

FIG. 3 exemplarily illustrates an optical signal with an AM tone applied according to some example embodiments of the present disclosure.

Referring to FIG. 3, a graph 300 plotting the power variation of the optical signal over time is shown. The graph 300 illustrates the amplitude modulation characteristics of a high-speed data optical signal with an AM tone applied.

In an example embodiment, the modulation index (MI) may be defined by the following equation:

$$MI = \frac{{P}_{max} - {P}_{min}}{{P}_{max} + {P}_{min}}$$

Pmax and Pmin represent the maximum power and minimum power of the optical signal, respectively. In the above equation, MI quantitatively represents the degree of amplitude modulation in the optical signal, and a larger MI value indicates greater amplitude variation. Notably, as Pmin decreases and approaches zero, MI approaches 1. In this case, the amplitude of the optical signal varies significantly, maximizing the effectiveness of the AM tone for tracking. However, if Pmin becomes too small, the original high-speed data signal may become distorted or lost in the low-power region of the optical signal, potentially causing degradation in data integrity. Therefore, in this example embodiment, the system may be designed to maintain a balance between tracking efficiency and data accuracy by appropriately adjusting the MI value through the level controller 260.

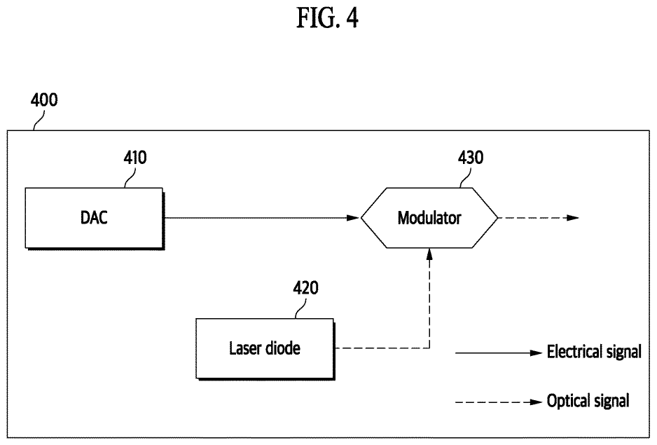

FIG. 4 is a schematic diagram illustrating each configuration of an optical transmission system that implements an AM tone modulation function using a DAC according to some example embodiments of the present disclosure. The system 400 shown in FIG. 4 depicts only the components relevant to the present example embodiment. Therefore, it is obvious to those skilled in the art that the system 400 may further include other general-purpose components in addition to those shown in FIG. 4.

Referring to FIG. 4, components of the optical transmission system 400 according to some example embodiments of the present disclosure are illustrated. In an example embodiment, the optical transmission system 400 includes a digital-to-analog converter (DAC) 410 configured to output an electrical signal with an AM tone applied, a laser diode 420 configured to generate a source optical signal, and a modulator 430 configured to modulate the electrical signal into a target optical signal with an AM tone applied based on the source optical signal. In an example embodiment, the optical transmission system 400 may be included within a laser communication terminal performing laser communication between space and the ground.

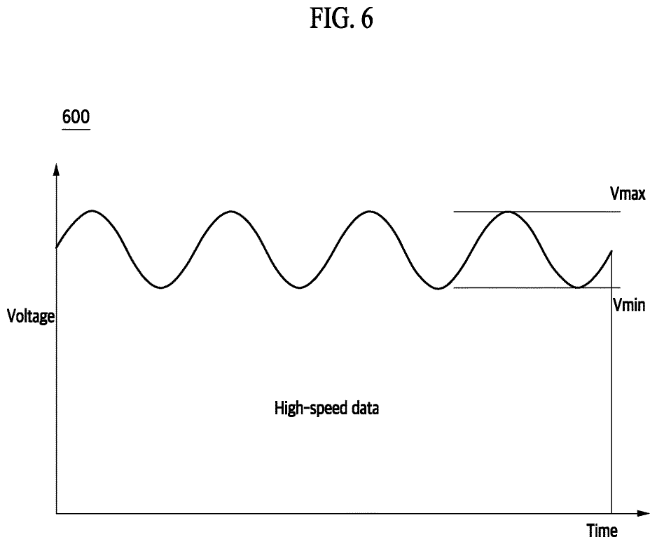

In an example embodiment, the DAC 410 is a component that converts digital data into an analog electrical signal for output and may include a high-speed DAC. Compared to the optical transmission system 100 of FIG. 1, the DAC 410 may generate the electrical signal in place of the transmitter 110 of FIG. 1. In an example embodiment, the DAC 410 may generate an electrical signal containing an AM tone, either internally or via external control, and transmit it to the modulator 430, rather than simply outputting high-speed data. That is, the DAC 410 may output not only the high-speed data electrical signal of 0 or 1, but also an AM tone with an arbitrary frequency based on the MI value, as shown in FIG. 6. This approach offers the advantage of integrating AM tone modulation functionality without requiring a separate AM tone generation circuit, such as the variable optical attenuator 140 shown in FIG. 1.

In an example embodiment, the laser diode 420 may include a tunable laser diode capable of generating an optical signal of a desired wavelength. The source optical signal generated by the laser diode 420 is supplied to the modulator 430, where it may be modulated into a target optical signal corresponding to an electrical signal.

In an example embodiment, the modulator 430 may modulate the source optical signal into the target optical signal according to the electrical signal, based on the electrical signal output from the DAC 410 and the source optical signal output from the laser diode 420. Ultimately, the target optical signal output from the modulator 430 may be output as an optical signal with an AM tone applied, as shown in FIG. 3.

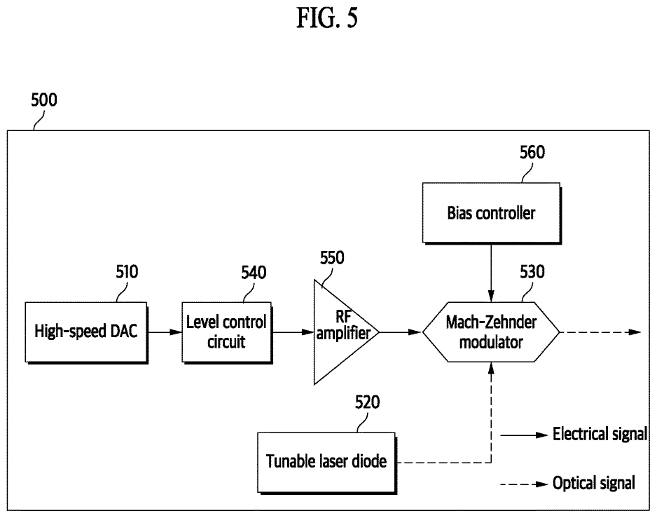

FIG. 5 is a schematic diagram illustrating each configuration of an optical transmission system that implements an AM tone modulation function using a DAC according to some example embodiments of the present disclosure. The system 500 shown in FIG. 5 depicts only the components relevant to the present example embodiment. Therefore, it is obvious to those skilled in the art that the system 500 may further include other general-purpose components in addition to those shown in FIG. 5.

Referring to FIG. 5, components of an optical transmission system 500 according to some example embodiments of the present disclosure are illustrated. In an example embodiment, the optical transmission system 500 includes a high-speed DAC 510 configured to output an electrical signal with an AM tone applied, a tunable laser diode 520 configured to generate a source optical signal, a Mach-Zehnder modulator 530 configured to modulate the electrical signal into a target optical signal with an AM tone applied based on the source optical signal, a level control circuit 540 configured to perform level optimization for amplifying the electrical signal output from the high-speed DAC 510, an RF amplifier 550 configured to amplify the level of the electrical signal, and a bias controller 560 configured to adjust the bias of the Mach-Zehnder modulator 530. In an example embodiment, the optical transmission system 500 may be included within a laser communication terminal performing laser communication between space and the ground.

In an example embodiment, the high-speed DAC 510 may generate and output a high-speed analog electrical signal containing an AM tone based on digital data. The output electrical signal is used as the optical modulation input to the Mach-Zehnder modulator 530, enabling simultaneous high-speed data transmission and AM tone insertion.

In an example embodiment, the level control circuit 540 may perform level optimization for amplifying the electrical signal output from the high-speed DAC 510 and transmit it to the RF amplifier 550. The level control circuit 540 may serve to optimize the electrical signal output from the DAC to an appropriate level for input to the modulator. Since distortion may occur in the amplifier if the DAC output is too small or too large, the level control circuit 540 may scale the voltage amplitude (level) of the electrical signal to match the input range where the RF amplifier 550 may operate optimally.

In an example embodiment, the RF amplifier 550 may amplify the level of the electrical signal output from the high-speed DAC 510 and deliver it to the Mach-Zehnder modulator 530. The RF amplifier 550 may amplify the level of the electrical signal to a range acceptable to the modulator.

In an example embodiment, the tunable laser diode 520 may generate an optical signal of a desired wavelength. The source optical signal generated by the tunable laser diode 520 may be supplied to the Mach-Zehnder modulator 530 to be modulated into a target optical signal corresponding to the electrical signal.

In an example embodiment, the Mach-Zehnder modulator 530 may modulate the source optical signal into the target optical signal according to the electrical signal, based on the electrical signal output from the high-speed DAC 510 and the source optical signal output from the tunable laser diode 520.

In an example embodiment, the bias controller 560 may adjust the bias voltage of the Mach-Zehnder modulator 530. In an example embodiment, the bias controller 560 may control the bias voltage of the Mach-Zehnder modulator 530 to ensure the Mach-Zehnder modulator 530 operates stably within its linear operating region. In an example embodiment, the bias controller 560 detects drift phenomena where the bias gradually changes due to disturbances such as temperature changes, power supply noise, or load variations that may occur during operation of the Mach-Zehnder modulator 530, and automatically compensates for this. This helps the Mach-Zehnder modulator 530 maintain stable modulation performance over extended periods.

FIG. 6 exemplarily illustrates a DAC output electrical signal with an AM tone applied according to some example embodiments of the present disclosure.

Referring to FIG. 6, a graph 600 plotting the voltage change of the electrical signal output from the DAC over time is shown. The graph 600 exhibits the characteristics of an AM tone superimposed on the electrical signal carrying high-speed data, causing the amplitude to change periodically, with the maximum voltage Vmax and minimum voltage Vmin indicated.

In an example embodiment, the DAC may be configured to identify a target modulation index and determine the amplitude of the AM tone corresponding to the target modulation index. The DAC may identify the target modulation index required by the system and determine the amplitude of the AM tone to be applied to the output electrical signal based on that MI value.

In an example embodiment, the modulation index (MI) may be defined by the following equation:

$$MI = \frac{{V}_{max} - {V}_{min}}{{V}_{max} + {V}_{min}}$$

Here, as the MI value increases, the amplitude variation of the voltage becomes larger, which allows the AM tone to be expressed more clearly and improves tracking performance at the receiving terminal. However, if Vmin becomes excessively small, the electrical signal may become distorted or data loss may occur. Therefore, the DAC needs to control the amplitude of the AM tone within an appropriate range based on the target modulation index.

The optical transmission system incorporating the AM tone modulation function according to some example embodiments of the present disclosure may provide the following effects. First, by selecting the wavelength of the source optical signal using a tunable laser diode and feeding it into the modulator, precise wavelength selection of the desired optical signal becomes possible. This enhances the wavelength flexibility of the system and enables adaptation to various communication environments. Second, applying AM tone modulation using a high-speed variable optical attenuator allows dynamic adjustment of the optical signal's amplitude, enabling fine-tuning of the modulation index (MI). This improves the efficiency and signal quality of the AM tone modulation. Finally, by transmitting high-quality optical signals with applied AM tones through the optical transmission system of this disclosure, the tracking performance of space optical communication terminals is enhanced, enabling high-speed data transmission and reliable communication. Therefore, this disclosure provides technical advantages that significantly improve signal quality, modulation performance, and system flexibility through the effective application of AM tone modulation in optical communication systems.

In some example embodiments, the optical transmission system 100, 200, 400, and 500 may further include a processor. The processor may be connected to at least some of the other components within the optical transmission system and may perform the role of controlling the overall functionality of the system. For example, the processor may execute programs stored in memory (not shown) within the system to control the system overall. The processor may be implemented as a CPU (central processing unit), GPU (graphics processing unit), AP (application processor), or the like provided within the system, but is not limited thereto.

In some example embodiments, the optical transmission system 100, 200, 400, and 500 may further include memory (not shown). The memory is hardware that stores various data processed within the system, which may store data processed by the system and data to be processed. The memory may be transitory or non-transitory. Additionally, the memory may store applications, drivers, etc., to be driven by the system. The memory may include RAM (random access memory) such as DRAM (dynamic random access memory) or SRAM (static random access memory), ROM (read-only memory), EEPROM (electrically erasable programmable read-only memory), CD-ROM, Blu-ray or other optical disk storage, HDD (hard disk drive), SSD (solid state drive), or flash memory.

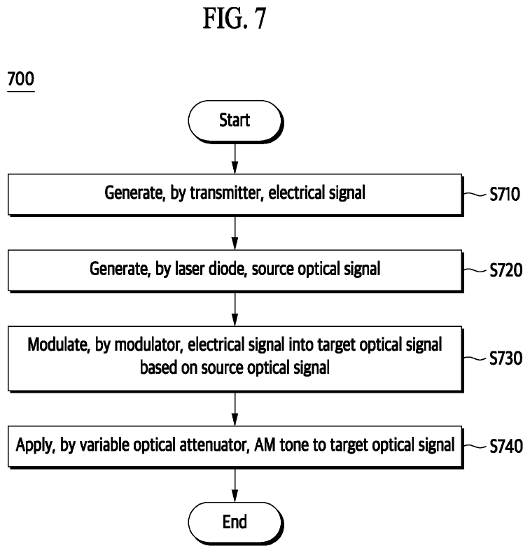

FIG. 7 is a flowchart illustrating an operating method of an optical transmission system including a variable optical attenuator according to some example embodiments of the present disclosure. Each operation of the operating method 700 illustrated in FIG. 7 may be performed by the system illustrated in FIG. 1. Descriptions overlapping with those described above may be omitted below.

In operation S710, the transmitter of the optical transmission system may generate an electrical signal.

In operation S720, the laser diode of the optical transmission system may generate a source optical signal.

In operation S730, the modulator of the optical transmission system may modulate the electrical signal into a target optical signal based on the source optical signal.

In operation S740, the variable optical attenuator of the optical transmission system may apply an AM tone to the target optical signal.

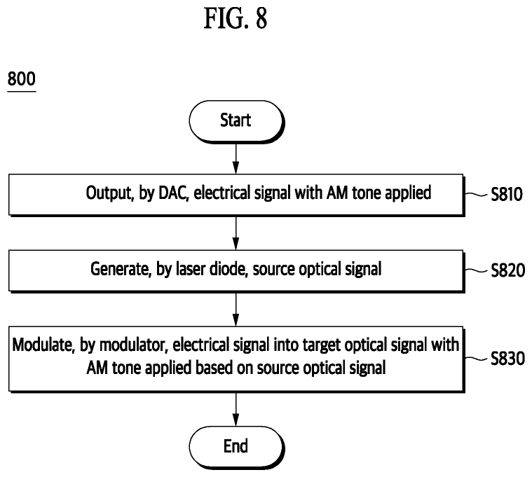

FIG. 8 is a flowchart illustrating an operating method of an optical transmission system including a DAC according to some example embodiments of the present disclosure. Each operation of the operating method 800 illustrated in FIG. 8 may be performed by the system 400 illustrated in FIG. 4. Descriptions overlapping with those described above may be omitted below.

In operation S810, the DAC of the optical transmission system may output an electrical signal with an AM tone applied.

In operation S820, the laser diode of the optical transmission system may generate a source optical signal.

In operation S830, the modulator of the optical transmission system may modulate the electrical signal into a target optical signal with an AM tone applied, based on the source optical signal.

According to example embodiments, it is possible to expect the following effects. First, by selecting the wavelength of the source optical signal using a tunable laser diode and feeding it into the modulator, precise wavelength selection of the desired optical signal becomes possible. This enhances the wavelength flexibility of the system and enables adaptation to various communication environments. Second, applying AM tone modulation using a high-speed variable optical attenuator allows dynamic adjustment of the optical signal's amplitude, enabling fine-tuning of the modulation index (MI). This improves the efficiency and signal quality of the AM tone modulation. Finally, by transmitting high-quality optical signals with applied AM tones through the optical transmission system of this disclosure, the tracking performance of space optical communication terminals is enhanced, enabling high-speed data transmission and reliable communication. Therefore, this disclosure provides technical advantages that significantly improve signal quality, modulation performance, and system flexibility through the effective application of AM tone modulation in optical communication systems.

The effects of the present disclosure are not limited to those mentioned above, and other effects not mentioned herein will be clearly understood by those skilled in the art from the following description.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure may be implemented in addition to the example embodiments disclosed herein.

The electronic device or terminal according to the above-described example embodiments may include a processor, a memory for storing and executing program data, a permanent storage such as a disk drive, a communication port for communicating with an external device, a user interface device such as a touch panel, a key, an icon, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, Python, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

It will be apparent to those skilled in the art that various modifications and variations can be made in the systems, devices, methods, and instructions for optical transmission of the present disclosure without departing from the spirit or scope of the invention. Thus, it is intended that the present invention cover the modifications and variations of this invention provided they come within the scope of the appended claims and their equivalents.

1. An optical transmission system comprising:
a transmitter configured to generate an electrical signal;
a laser diode configured to generate a source optical signal;
a modulator configured to modulate the electrical signal into a target optical signal based on the source optical signal;
a variable optical attenuator (VOA) configured to apply an amplitude modulation (AM) tone to the target optical signal;
an oscillator configured to generate an electrical signal with the AM tone; and
a level controller configured to adjust the AM tone,
wherein the level controller is further configured to identify a target modulation index (MI) and adjust the AM tone such that the target optical signal corresponds to the target MI, and
the target MI is defined based on a difference between a maximum power and a minimum power of the target optical signal.

2. (canceled)

3. (canceled)

4. The optical transmission system of claim 1, further comprising a radio frequency (RF) amplifier configured to amplify a level of the electrical signal to deliver to the modulator.

5. The optical transmission system of claim 1, wherein the modulator comprises a Mach-Zehnder modulator, and
the optical transmission system further comprises a bias controller configured to adjust a bias voltage of the Mach-Zehnder modulator.

6. An optical transmission system comprising:
a digital-to-analog converter (DAC) configured to output an electrical signal with an AM tone applied;
a laser diode configured to generate a source optical signal; and
a modulator configured to modulate the electrical signal into a target optical signal with the AM tone applied based on the source optical signal,
wherein the DAC is further configured to identify a target MI and adjust the AM tone such that the target optical signal corresponds to the target MI, and
the target MI is defined based on a difference between a maximum voltage and a minimum voltage of the electrical signal.

7. (canceled)

8. The optical transmission system of claim 6, further comprising:
a level control circuit configured to perform level optimization for amplifying the electrical signal output from the DAC; and
an RF amplifier configured to amplify a level of the electrical signal to deliver to the modulator.

9. The optical transmission system of claim 6, wherein the modulator comprises a Mach-Zehnder modulator, and
the optical transmission system further comprises a bias controller configured to adjust a bias voltage of the Mach-Zehnder modulator.

10. An operating method of an optical transmission system, the operating method comprising:
generating an electrical signal by a transmitter;
generating a source optical signal by a laser diode;
modulating the electrical signal into a target optical signal based on the source optical signal by a modulator; and
applying an amplitude modulation (AM) tone to the target optical signal by a variable optical attenuator,
wherein the variable optical attenuator is coupled to:
an oscillator configured to generate an electrical signal with the AM tone; and
a level controller configured to adjust the AM tone,
wherein the applying of the AM tone comprises:
identifying, by the level controller, a target MI; and
adjusting, by the level controller, the AM tone such that the target optical signal corresponds to the target MI, and
the target MI is defined based on a difference between a maximum power and a minimum power of the target optical signal.

11. An operating method of an optical transmission system, the operating method comprising:
identifying a target MI by a digital-to-analog converter (DAC);
adjusting, by the DAC, an amplitude modulation (AM) tone such that an electrical signal with the AM tone applied corresponds to the target MI;
outputting the electrical signal with the AM tone applied by the DAC;
generating a source optical signal by a laser diode; and
modulating the electrical signal into a target optical signal with the AM tone applied based on the source optical signal by a modulator,
wherein the target MI is defined based on a difference between a maximum voltage and a minimum voltage of the electrical signal.
